(19) United States
(12) Patent Application Publication
(10) Pub. No.: US 2019/0289837 A1
(43) Pub. Date: Sep. 26, 2019

(54) REEL SEAT WITH REMOVABLE CAP

(71) Applicant: Aaron TECHLIN, Appleton, WI (US)

(72) Inventor: Aaron TECHLIN, Appleton, WI (US)

(21) Appl. No.: 16/352,138

(22) Filed: Mar. 13, 2019

Related U.S. Application Data
(60) Provisional application No. 62/645,946, filed on Mar. 21, 2018.

(51) Int. Cl. A01K 87/06; A01K 87/08

(52) U.S. Cl. CPC A01K 87/06; A01K 87/08

(57) ABSTRACT

One embodiment provides a reel seat including a first attachment to a rod along a longitudinal axis of the reel seat, a grip having one or more attachments to a handle along one or more attachment axes of the reel seat, and a removable cap covering the attachment of the grip.

### CROSS REFERENCE TO RELATED APPLICATIONS

This application claims the benefit of U.S. Provisional Patent Application No. 62/645,946 filed on Mar. 21, 2018. The contents of U.S. Provisional Patent Application 62/645,946 are hereby incorporated by reference.

### FIELD

The present invention relates to fishing rod reel seats in general, and more particularly to a fishing rod reel seat having a removable cap for accommodating an adaptable handle.

### BACKGROUND

Anglers must often continuously hold a fishing rod by hand over long periods of time while waiting for a fish to strike. Since the typical fishing rod is linear, and the tip of the rod must be pointed in the general direction of the water, the angler is forced to hold the rod with a rotated or bent wrist. Over time, this contortion of the wrist can cause discomfort, fatigue or injury. Furthermore, the potential for discomfort, fatigue or injury to the wrist is exacerbated when a fish strikes and the angler must maintain a strong grip on the rod, or when the angler must make a repeated motion involved in casting a lure. Altogether, fishing for long periods of time can place a substantial strain on the wrist, arm, neck, back and shoulders of the angler. Several rod configurations have been proposed to ameliorate these risks, but there remains a need for improvement.

A grip that extends in a perpendicular direction from a fishing rod is useful for the angler's handling of a fishing rod, and may reduce the potential for wrist discomfort, fatigue, or injury. However, such an extension becomes a hindrance to storage when a fishing rod is not in use and can interfere with an angler carrying multiple fishing rods at the same time. Moreover, the placement of a perpendicular extension may be useful for some types of fishing, but may be a hindrance for other types of fishing. Thus, there is a need for an improved vertical extension grip that can both reduce the potential for wrist injury, while also being easily removed when not in use and easily repositioned for alternative types of fishing.

Other generally rod-shaped objects must be held by hand and similarly pose the potential for bodily fatigue or injury. Thus, there is a need for an improved grip for holding generally rod shaped objects.

### SUMMARY OF THE INVENTION

The invention described herein overcomes the deficiencies of current fishing rod designs with respect to the positioning of the angler's wrist, and overcomes handling and storage problems of vertical grips when the rod is not in use. Among other things, the present invention provides various fishing rod grips that are removably attachable to a fishing rod.

One or more embodiments of the present invention provides a top half of a bracket and a bottom half of a bracket that are adapted to girdle a fishing rod. Either the top half or bottom half or both are attached to a grip that projects substantially perpendicularly from the length of the girdled rod. Specifically, one or more embodiments may comprise a grip having a top and a bottom. The top of the grip may be adapted to receive a bolt having a first end and a second end. The top half of a bracket may have a substantially concave form defining a first interior area substantially in the shape of a half-cylinder. The bottom half of the bracket may have a substantially concave form defining a second interior area substantially in the shape of a half-cylinder. The top half and the bottom half of the bracket may be reversibly mated, with the flat part of the first interior area junctioning with the flat part of the second interior area to form a single interior area substantially in the shape of a cylinder. This interior area is the space around which the fishing rod grip may girdle the rod. The top of the grip may be reversibly mated with a first end of a bolt and either the top half or the bottom half are reversibly mated with the second end of the bolt. Thus, the present invention provides a means for both attaching a fishing rod grip in a desired position along the length of a rod, and also provides a means for easily attaching and removing a grip to the mated bracket halves girdling the rod.

In other embodiments, the fishing rod grip of the present invention may comprise a top half defining one or more individual through-holes and a bottom half defining one or more individual receptor holes. The one or more individual through-holes may line up directly with the individual receptor holes and may be adapted to receive a threaded end of a bolt. In this manner, the top half and the bottom half may be held in a mated position girdling a fishing rod by screwing a bolt in place through the top half into the bottom half, thereby pinching the fishing rod between. The benefits of this system are that the fishing rod grip may be placed at any point along the length of a fishing rod.

In other embodiments, the fishing rod grip of the present invention may comprise a top half defining through-holes that are low-relief. In this manner, the head of a bolt would be below the upper surface of the top half, when the top half and the bottom half are reversibly bolted together. This type of debossed though-hole prevents an angler's hand or other material from getting scratched, or prevents any other material getting entangled by the head of the bolt.

In one or more embodiments, a flexible material may be attached to the concave side of the top half and bottom half of the bracket. This material may enhance the clenching of the top half and bottom half around the fishing rod when in a mated position. Furthermore, a grasp enhancing material may be attached to the outer surface of the grip. This material can serve the purpose of both helping the angler to keep a grasp on the grip and also provide additional comfort.

In one or more embodiments, the grip of the fishing rod grip may have a frustoconical shape and also define an interior space. The grip may further comprise interior support beams to enhance its strength. Other grip shapes and structures are possible, however, including a solid or hollow cylinder shape or hour-glass shape, among others.

Similarly, one or more embodiments of the bracket aspect of the invention may be formed into a variety of hollow or solid shapes. In some embodiments, the top half and the bottom half may be adapted to girdle a fishing rod.

The top half, bottom half, and the grip may optionally be made of steel, wood, plastic, aluminum, hardened rubber, carbon fiber, nylon, fiberglass, graphite, thermoplastics, hybrid mixtures of metal and composites, or any other substantially stiff material.

In one or more embodiments, a rod comprises a longitudinal axis and a grip adapted for attachment directly to the rod along an attachment axis that is transverse to the longitudinal axis of the rod.

In one or more embodiments, a rod comprises a reel seat having a trigger portion below the reel seat and further comprising a removable cap for accommodating an adaptable handle.

While some embodiments of the invention described herein may be adapted to girdle a fishing rod, other embodiments of the invention may be adapted to girdle other rod-shaped objects which are used in a manner involving push, pull or lift motions. For example, some embodiments of the present invention may be adapted to girdle brooms, shovels, rakes, hoes, tampers, picks, axes, crowbars, pry bars, tree pruners, fruit pickers, sidewalk scrapers, paint roller poles, post-hole diggers, pole saws, sickles, grass hooks, pitch forks, garden tillers, ground aerator, root irrigators, and the like. By way of non-limiting, specific example, one or more embodiments of the invention may be adapted to girdle the forestock (fore-end) or barrel of a riffle. The description of various embodiments of the present invention as being adapted to girdling a fishing rod should not be read as limiting the invention to those particular configurations.

### BRIEF DESCRIPTION OF DRAWINGS

FIG. 1 illustrates a perspective view of one embodiment of the present invention attached to a typical linear fishing rod.

FIG. 2A illustrates a cross sectional side view of one embodiment of the grip part of the present invention.

FIG. 2B illustrates a perspective view of one embodiment of the grip part of the present invention.

FIG. 2C illustrates a top view of one embodiment of the grip part of the present invention.

FIG. 2D illustrates a side view of one embodiment of the grip part of the present invention.

FIG. 2E illustrates a bottom view of one embodiment of the grip part of the present invention.

FIG. 3A illustrates a cross sectional side view of one embodiment of the top half of the bracket part of the present invention.

FIG. 3B illustrates a top view of one embodiment of the top half of the bracket part of the present invention.

FIG. 3C illustrates a perspective view of one embodiment of the top half of the bracket part of the present invention.

FIG. 3D illustrates a side view of one embodiment of the top half of the bracket part of the present invention.

FIG. 3E illustrates another side view of one embodiment of the top half of the bracket part of the present invention.

FIG. 3F illustrates another side view of one embodiment of the top half of the bracket part of the present invention.

FIG. 3G illustrates a bottom view of one embodiment of the top half of the bracket part of the present invention.

FIG. 4A illustrates a cross sectional side view of the bottom half of one embodiment of the bracket part of the present invention.

FIG. 4B illustrates a top view of the bottom half of one embodiment of the bracket part of the present invention.

FIG. 4C illustrates a perspective view of the bottom half of one embodiment of the bracket part of the present invention.

FIG. 4D illustrates another side view of the bottom half of one embodiment of the bracket part of the present invention.

FIG. 4E illustrates another side view of the bottom half of one embodiment of the bracket part of the present invention.

FIG. 4F illustrates another side view of the bottom half of one embodiment of the bracket part of the present invention.

FIG. 4G illustrates a bottom view of the bottom half of one embodiment of the bracket part of the present invention.

FIG. 5A illustrates a cross sectional top view of the bracket part of the present invention.

FIG. 5B illustrates a side view of one embodiment of the grip part of the present invention.

FIG. 5C illustrates a side view of another embodiment of the grip part of the present invention.

FIG. 5D illustrates a perspective view of one embodiment of the present invention attached to a typical linear fishing rod.

FIG. 6A illustrates a cross sectional side view of a partially assembled embodiment of the present invention.

FIG. 6B illustrates another cross sectional side view of one embodiment of a partially assembled fishing rod grip of the present invention.

FIG. 7 illustrates a side view of a partially dissembled embodiment of the present invention.

FIG. 8A illustrates a side view of a partially disassembled embodiment of the present invention and FIG. 8B illustrates an assembled view of such embodiment.

FIG. 9A illustrates one embodiment of the present invention showing a reel seat with a removable trigger cap.

FIG. 9B and FIG. 9C illustrate one embodiment of a reel seat in accordance with the present disclosure.

FIG. 9D illustrates one embodiment of a reel seat shown with a removable cap removed from the reel seat.

FIGS. 9E and 9F each illustrate one embodiment of a reel seat showing the attachment of an adaptable handle.

FIG. 9G illustrates one embodiment of a rod including a reel seat having a removable trigger cap.

FIG. 9H illustrates one embodiment of a rod shown with a handle attached to the reel seat.

FIGS. 10A-D illustrate embodiments of rods.

FIG. 11 illustrates embodiments of rods.

FIG. 12 illustrates an embodiment of a rod.

### DETAILED DESCRIPTION

This disclosure describes the best mode or modes of practicing the invention as currently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

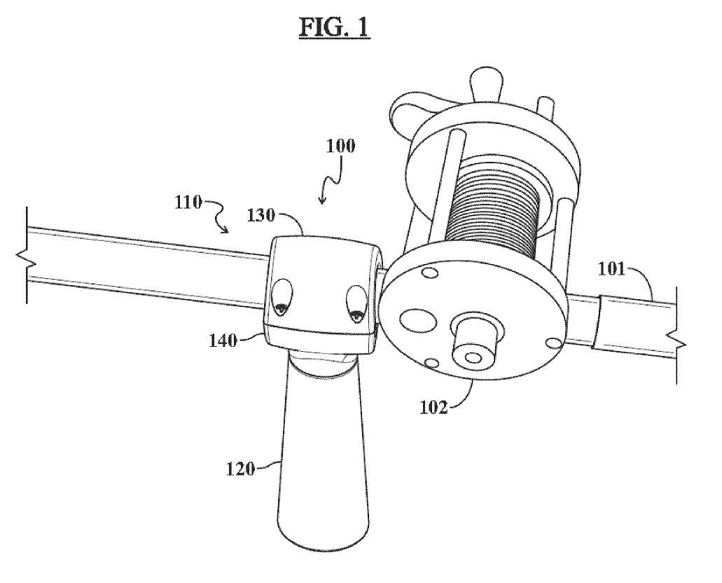

FIG. 1 shows an exemplary and non-limiting example of one embodiment of the fishing rod grip 100 of the invention. FIG. 1 illustrates a perspective view of a fishing rod grip 100 comprising a bracket 110 and a grip 120 as attached to a typical linear fishing rod 101. Specifically, the fishing rod grip 100 is attached via the bracket 110 which girdles the linear fishing rod 101. In this particular embodiment, the fishing rod grip 100 is attached to the rod 101 in a proximal position above the reel 102. In other embodiments of the present invention, the fishing rod grip 100 may be attached to the linear rod 101 in a position proximally below the reel 102. In yet other embodiments the fishing rod grip 100 may be attached to the fishing rod 101 and distal position below, or a distal position above, the reel 102. In the particular embodiment illustrated in FIG. 1, the grip 120 of the fishing rod grip 100 is positioned transverse-to the reel 102. In other words, in the embodiment seen in FIG. 1, the grip 120 is positioned on the far-side of the reel 102 on the fishing rod 101. Other embodiments of the grip 120 of the present invention 100 may be positioned cis-to the reel. In yet other embodiments, the grip 120 may be at any other position of rotation relative to the reel 102 around the linear fishing rod 101.

In another embodiment of the invention, the bracket 110 comprises an attached flexible material that contacts the fishing rod 101 while the bracket 110 girdles the rod. This flexible material can be composed of any padding or other material that is capable of being deformed or bent without breaking, and is adapted to accommodate girdling of fishing rods of varying diameters by the bracket 110. The flexible material is located substantially inside of the concave portions of the bracket, in a position between the bracket and the fishing rod.

In one or more embodiments, the bracket 110 and the grip 120 of the fishing rod grip 100 comprises a substantially inflexible material. For example, in one embodiment, the bracket 110 and the grip 120 are composed of stainless steel. Other substantially inflexible materials may be used as well, including plastic, aluminum, wood, hardened rubber, graphite, thermoplastics, hybrid mixtures of metal and composites.

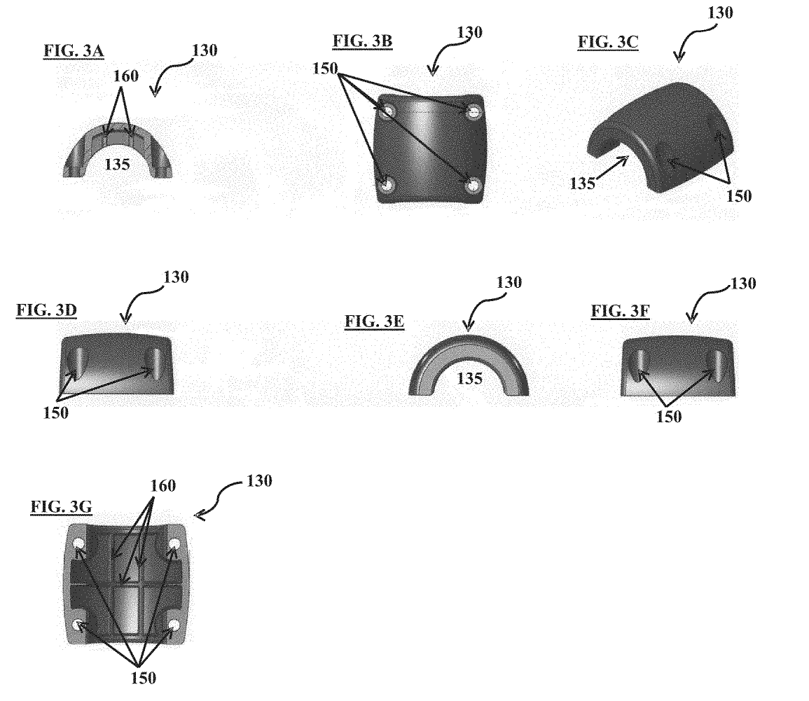

One or more embodiments of the present invention employ a bracket 110 that is comprised of a top half 130 and a bottom half 140. As can be seen in FIGS. 3 A, B, and E, one or more embodiments of the top half 130 may have a form that defines an interior space 135. In one embodiment, the interior space 135 is substantially in the shape of a half-cylinder, and is adapted to having a width at its widest that is substantially the same as the cross sectional diameter of a fishing rod. As seen in FIGS. 3 B and G, some embodiments of the top half 130 of the bracket 110 may have a substantially square shape when viewed from above. As can be seen in FIGS. 3 B, D, F, and G, one or more embodiments of the top half 130 of the bracket 110 may be adapted to define one or more through-holes 150. There are four separate though holes 150; each one located in a position that is substantially in the corners of a substantially square-shaped top half 130 of the bracket 110 when viewed from above. Other embodiments of the top half 130 of the bracket 110 of the present invention may comprise more than four, or less than four, through-holes 150.

As seen in FIGS. 3 A-G, the through-holes 150 may be partially or fully debossed in the top half 130 of the bracket 110. Debossed through-holes are oriented in a position that is perpendicular to the flat part of the half-cylinder interior space 135 that is defined by the top half 130. In other embodiments, however, debossed through-holes 150 may be oriented at various other angles relative to the flat part of the half-cylinder interior space 135, or oriented at various other angles relative to each other. In various embodiments, the through-holes 150 of the top half 130 may be adapted to allow the shank of a screw or bolt of varying sizes to substantially pass through the through hole 150.

As seen in FIGS. 3 A and G, the top half 130 of the bracket 110, may be comprised of one or more support beams 160. These support beams 160 may be continuous with the rest of the top half 130, or may be separate structures that are attached to the top half 130. As seen in FIGS. 3 A and G, in one embodiment, the support beams 160 are adapted to support the structure of the top half 130 by resisting bending stresses from a direction perpendicular to the support beam 160 length. Any substantially inflexible material may comprise the support beams 160 such as stainless steel, plastic, aluminum, wood, hardened rubber, graphite, thermoplastics, hybrid mixtures of metal and composites. In the embodiment illustrated in FIGS. 3 A and G, there are two parallel support beams 160 perpendicular to a single support beam 160. However, in various embodiments, the top half 130 may comprise one or more support beams 160 oriented at various other positions relative to each other.

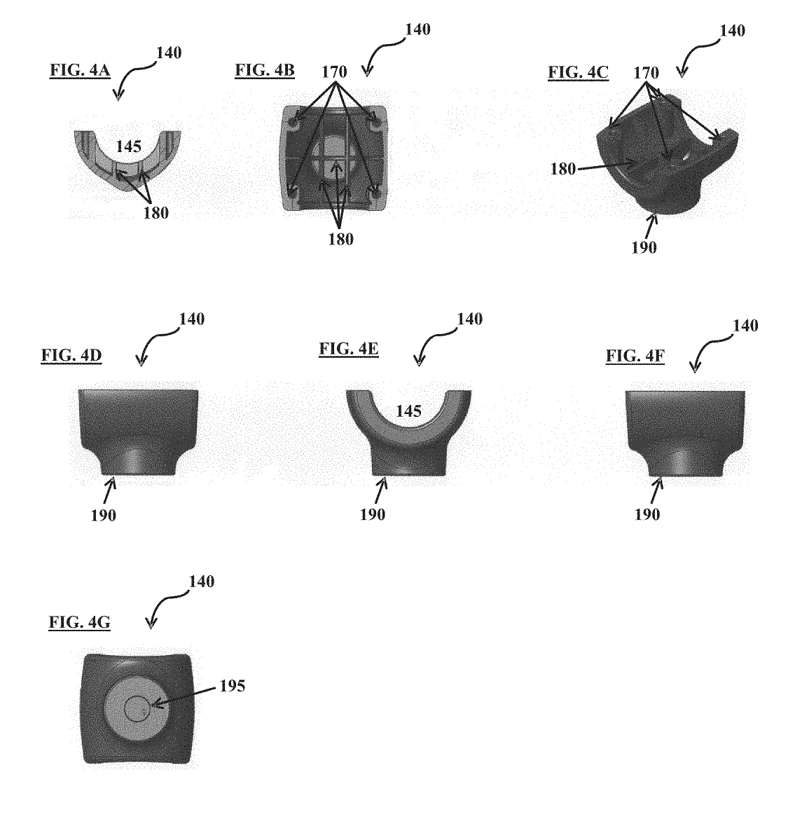

As can be seen in FIGS. 4 A, C, and E, one or more embodiments of the bottom half 140 of the bracket 110 have a form that defines an interior space 145. The interior space 145 is substantially in the shape of a half-cylinder and is adapted to have a width at its widest point that is substantially the same as the cross sectional diameter of a fishing rod. Some embodiments of the bottom half 140 of the bracket 110 may have a substantially square shape when viewed from above (FIG. 4 b) or below (FIG. 4 g). As seen in FIGS. 4 A, B, and C, the bottom half 140 may be adapted to define one or more receptor holes 170. The receptor holes 170 are adapted to receive the shank of a bolt or screw. There are four separate receptor holes 170; each hole 170 located in a position that is substantially in the corners of a substantially square-shaped bottom half 140 of the bracket 110. Other embodiments of the bottom half 140 of the bracket 110 of the present invention may comprise more than four or less than four receptor holes 170. Receptor holes 170 are oriented in a position that is perpendicular to the flat part of the semi-circle interior space 145 that is defined by the bottom half 140. In other embodiments, however, receptor holes 170 may be oriented at various other angles relative to the flat part of the semi-circle interior space 145, or oriented at various other angles relative to each other.

As seen in FIGS. 4 A and B, the bottom half 140 of the bracket 110, may be comprised of one or more support beams 180. These support beams 180 may be continuous with the rest of the bottom half 140, or may be separate structures that are attached to the bottom half 140. As seen in FIGS. 4 A and B, the support beams 180 are adapted to support the structure of the bottom half 140 by resisting bending stresses from a direction perpendicular to the support beam 180 length. Any substantially inflexible material may comprise the support beams 180 such as stainless steel, plastic, aluminum, wood, hardened rubber, graphite, thermoplastics, hybrid mixtures of metal and composites. As illustrated in FIG. 4 B, there are two parallel support beams 180 perpendicular to a single support beam 180. However, in various embodiments, the bottom half 140 may comprise one or more support beams 180 oriented at various other positions relative to each other.

As seen in FIGS. 4 C, D, E, and F, the bottom half 140 of the bracket 110, may comprise a projection 190 that extends outwardly from beneath the bottom half 140. In one or more embodiments, the projection 190 is adapted to receive the shank of a bolt or screw. Specifically, the projection 190 may define an empty space 195 which is capable of receiving a bolt or screw.

While some embodiments of the present invention have described the bracket 110 as reversibly girdling a generally rod-shaped object, other embodiments of the bracket 110 may be permanently fixed to the rod-shaped object. In some embodiments, the bracket 110 is permanently built into the generally rod shaped object, with the grip 120 being mateably detachable. Some embodiments may employ bolts or screws to permanently affix the bracket 110 to the generally rod-shaped object, while other embodiments may use adhesives. The description of various embodiments of the bracket 110 as adapted to being reversibly attached should not be read as limiting the invention to those particular configurations.

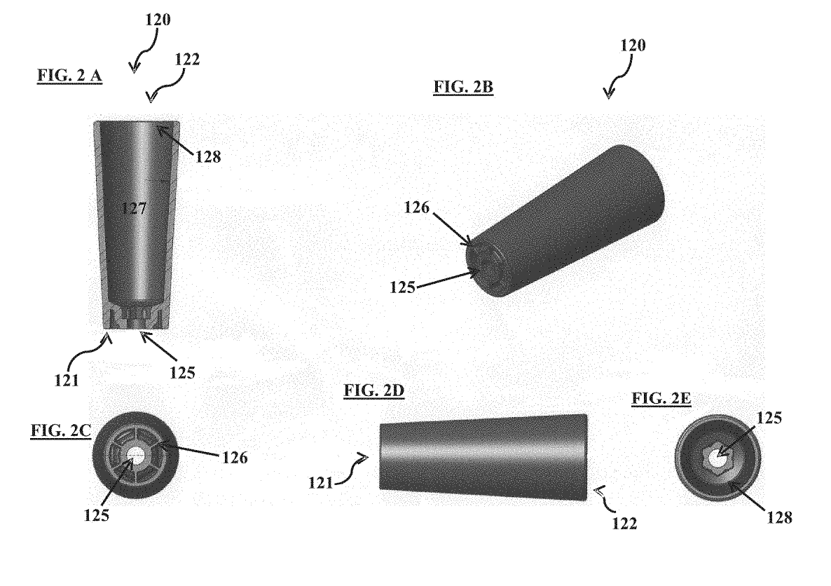

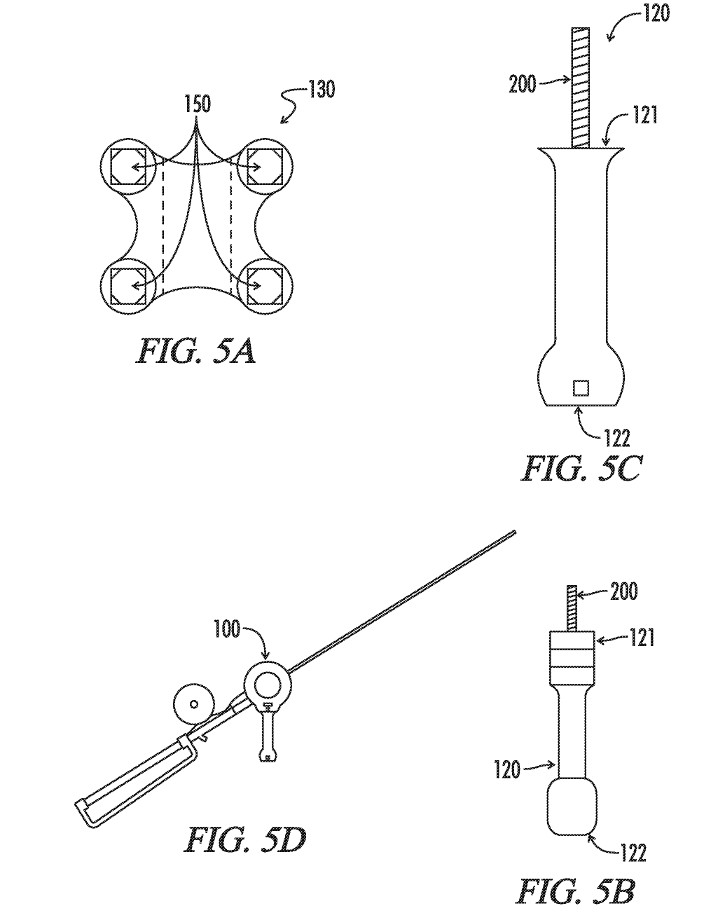

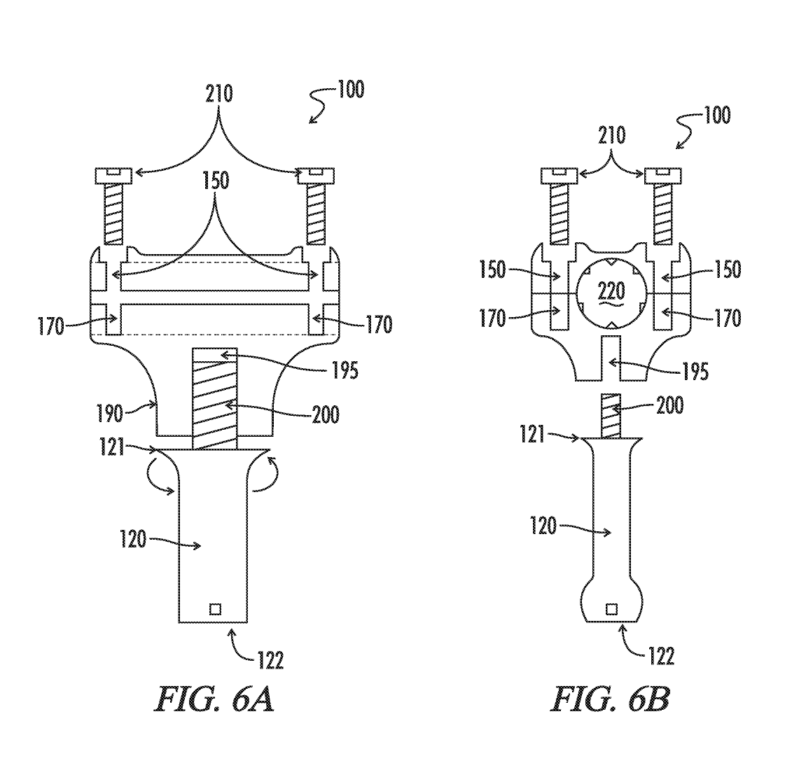

One or more embodiments of the present invention also comprise a grip 120 which may be detachably connected to the bracket 110. As seen in FIGS. 5 B and C, the grip 120 has a top 121 and a bottom 122, and may comprise a bolt 200 extending vertically from the top 121 of the grip 120. In one embodiment of the invention, the bolt 200 is adapted to be screwed into an empty space 195 defined by the projection 190 (FIG. 6). In some embodiments, the top of the grip 120 is fashioned so as to form a substantially continuous surface between the grip 120 and the projection 190 when the grip 120 and projection 190 are fully mated. As seen in FIGS. 2 A, B, C, D, and E, in some embodiments the grip may have a frustoconical shape. Also, as seen in FIG. 2A, in some embodiments the grip may define a hollow space 127. The grip of the present invention may also have an opening 125 in the top 121 of the grip 120 that is adapted to receive the shank of a bolt of a screw (FIGS. 2 A, C and E). Other embodiments may have a second opening 128 located on the bottom 122 of the grip 120 (FIGS. 2 A and E). The structure of the grip 120 may comprise one or more support beams 126. The support beams 126 may be positioned radially from the center of the opening 125 of the grip 120. In one or more embodiments, the outer surface of the grip 120 may comprise a material that enhances the angler's grip on the grip 120, or enhances the angler's comfort. For example, in one or more embodiments, the outer surface comprises foam padding.

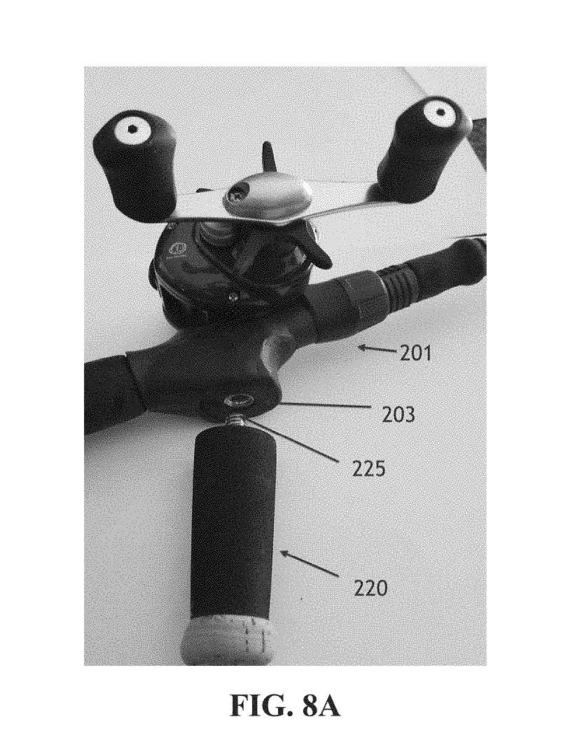

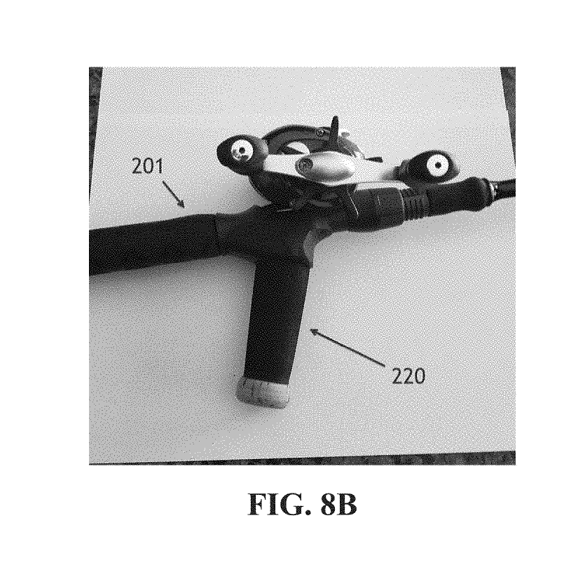

One or more embodiments of the present invention also comprise a grip 220 which may be detachably connected directly to a rod 201 as shown in FIGS. 8A and 8B. The grip 220 may be provided with a fastener 225, such as a bolt, screw or the like, that is adapted to be matingly attached to the rod 201 at location 203 (FIG. 8A). In one embodiment, if fastener 225 is a screw, then location 203 may be a threaded opening adapted to mate with the screw. In some embodiments, the top of the grip 220 is fashioned so as to form a substantially continuous surface between the grip 220 and the rod 201 when the grip 220 and rod 201 are fully mated as shown in FIG. 8B. The grip 220 may be any size, shape, or structural configuration, or angular orientation relative to the rod 201 when mated with the rod 201. In one embodiment, the grip 220 may be angularly oriented transverse to the longitudinal axis of the rod 201, and such orientation may be substantially perpendicular or perpendicular to the rod 201. The grip 220 may also be mated with the rod 201 in a removable configuration, semi-permanent configuration or a permanent configuration such as by a one-way press-fit (not shown) or the like. With a removable or replaceable configuration, the grip 220 may be switched with other grips (not shown) in the event it is desired to select a different grip for attachment to the rod 201. In a removable configuration, the grip 220 is simply detached from the rod 201 when use of the grip 220 is no longer desired. In one or more embodiments, the outer surface of the grip 220 may comprise a material that enhances the angler's grip on the grip 220, or enhances the angler's comfort. For example, in one or more embodiments, the outer surface comprises foam padding.

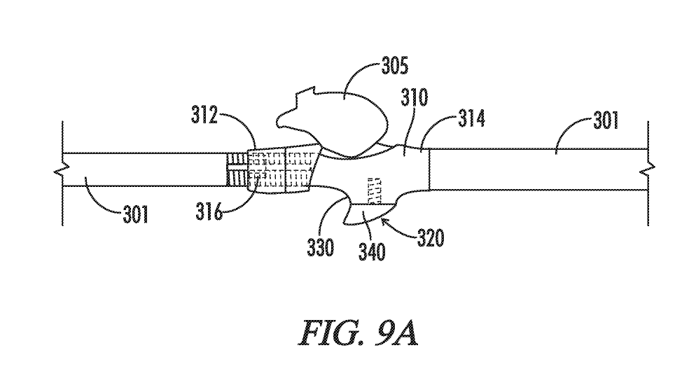

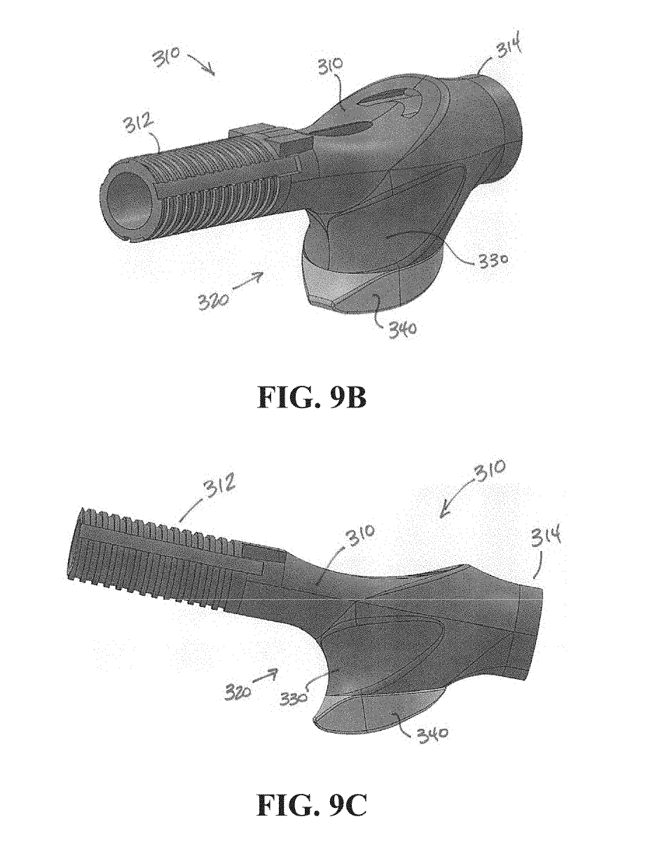

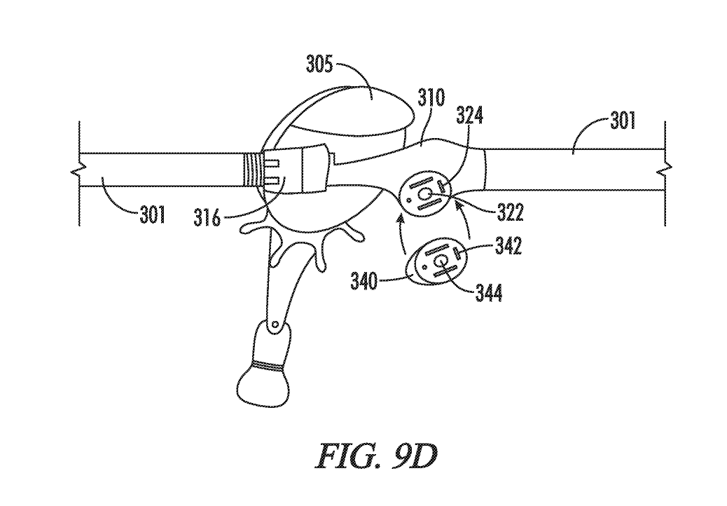

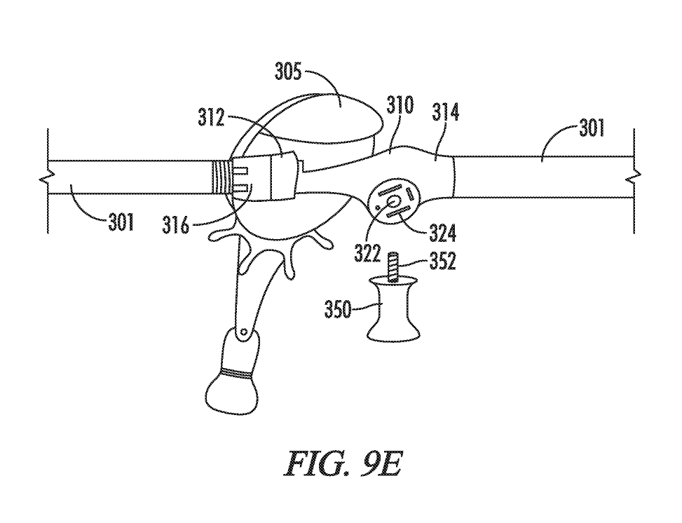

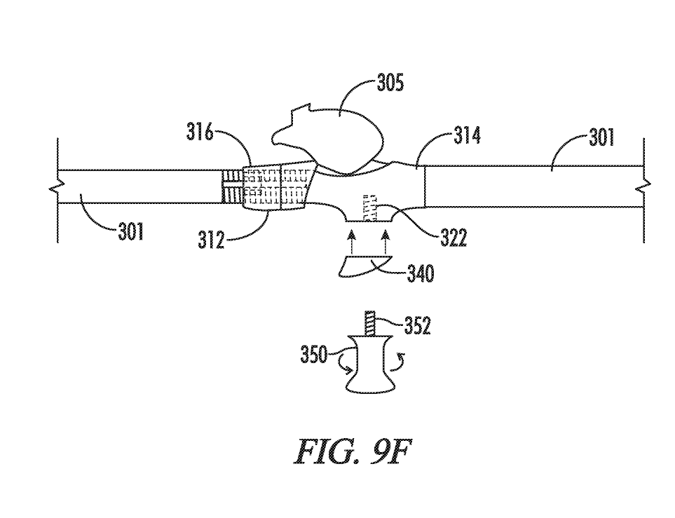

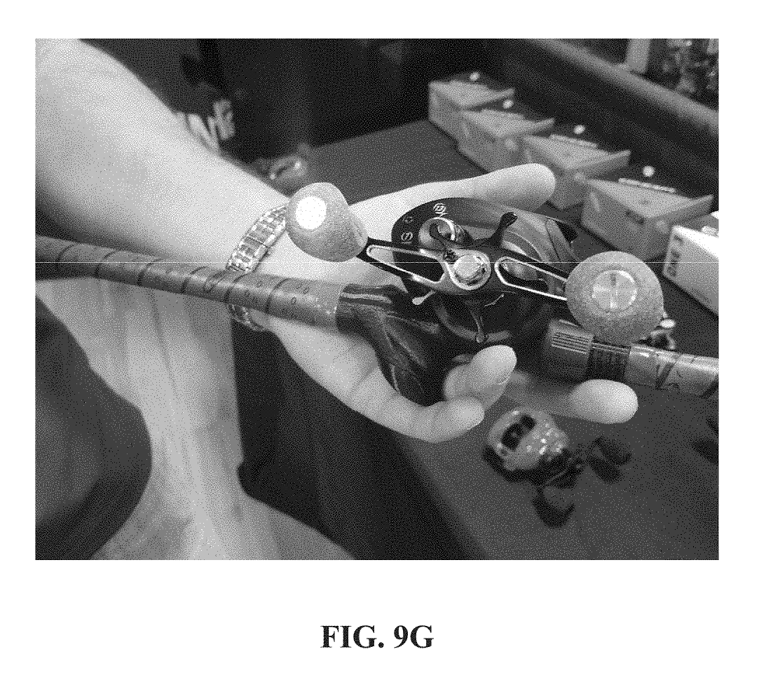

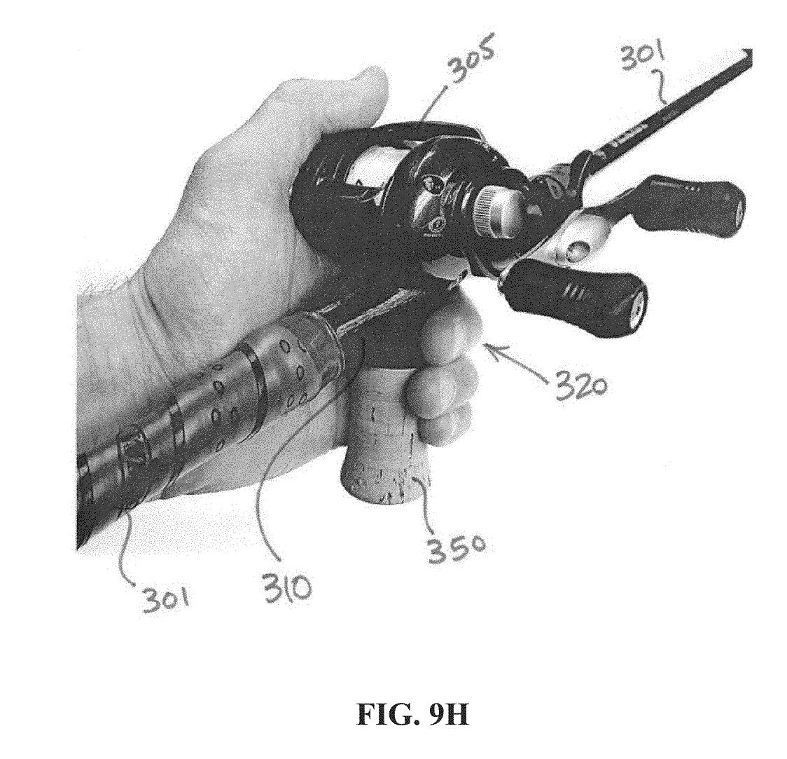

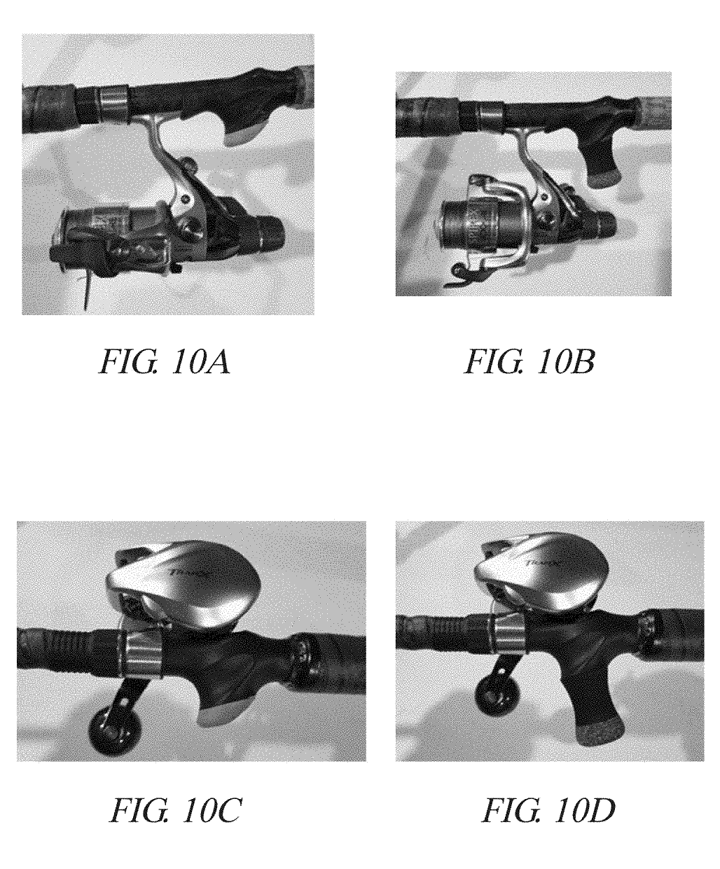

One or more embodiments of the invention comprise a rod 301 having a longitudinal axis and a reel seat 310 that may have a first attachment to the rod 301 along the longitudinal axis for accommodating a reel 305 as shown in FIGS. 9A through 9H. The reel seat may be used to any types of rod regardless of physical characteristics or molecular composition of the rod. The reel may have any shape including a shape shown in the figures. For example, the reel may be a spinning reel (see examples in FIGS. 10A and 10B) or a casting reel (see examples in FIGS. 10C and 10D). One embodiment of the reel seat 310 is attached to the rod 301 at a first end 312 and a second end 314, the first end 312 further comprising a reel seat hood 316 for attachment of the reel seat 310 to the rod 301 at the first end 312, the second end 314 typically being attached to the rod 301 through conventional methods. While the ends 312, 314 of the reel seat 310 are shown and described with a certain configuration, it will be appreciated that other configurations are possible.

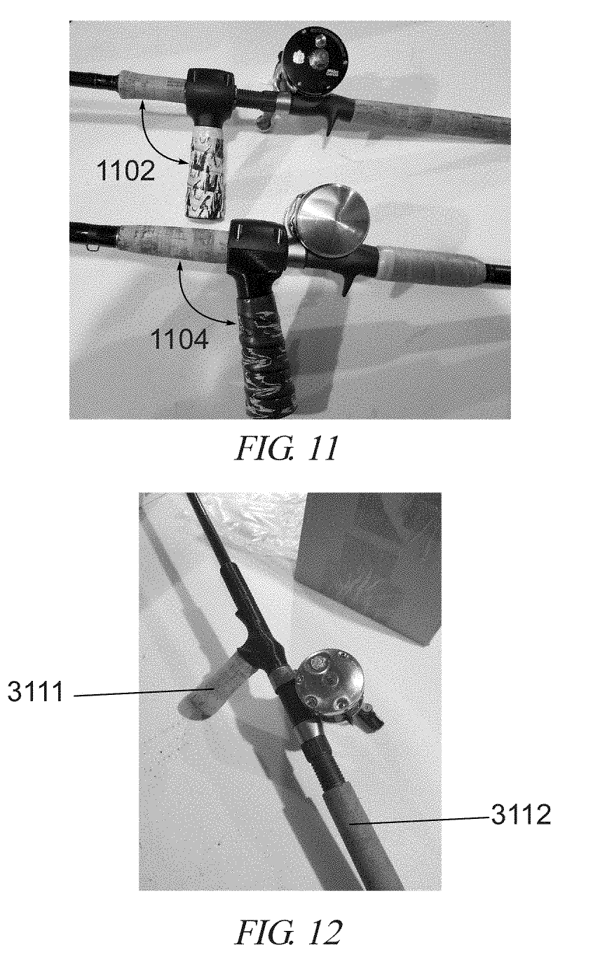

The reel seat 310 further comprises a trigger portion 320 for accommodating a user's grasp (see, for example, FIG. 9G), the trigger portion 320 further comprising a preferably contoured grip section 330 to accommodate a user's finger purchase and a removable cap 340 for engagement of an adaptable handle 350 (e.g., the grip section 330 may have a second attachment to the handle 350) with the reel seat 310 (see also FIGS. 8A and 8B) along an attachment axis that is transverse to the longitudinal axis of the rod 301. As shown in FIG. 11, an angle of the attachment axis to the longitudinal axis may be 90 degrees (see angle 1102 of the upper structure in FIG. 11), or any angle other than 90 degrees (see angle 1104 of the lower structure in FIG. 11). The angle 1104 may be larger than 90 degrees (as shown in FIG. 11) or smaller than 90 degrees (not shown). As shown in FIG. 12, a plurality of reel seats 3111 and 3112 may be provided in a rod before and after the reel. As shown in FIG. 12, the reel seat 3111 and 3112 may be disposed at different locations of the rod. The reel seat 3111 may be provided for gaining leverage. While two reel seats 3111 and 1332 are shown in FIG. 12, it is contemplated that additional or a plurality of reel seats may be attached at different locations of the rod depending on ergonomic requirements. An angle of the reel seat 311 is configured to encompass the rod 360 degrees, and may be fully adjustable. In one example, the handle of the reel seat 3111 can rotate 360 degrees around the axis of the rod while the reel seat 3111 remains fixed in the rod. While a removable cap 340 is described, it will be appreciated that the reel seat 310 may be used with the cap 340 attached to the reel seat 310. Removal of the cap 340 reveals a reel seat insert 322 (FIG. 9D) extending into the reel seat 310 for, in one embodiment, accommodating an engagement member 352 of an adaptable handle 350 (FIG. 9E), and guide inserts 324 on the reel seat for mating with guide extensions 342 on the removable cap 340 that assist with seating the cap 340 onto the reel seat 310. In one embodiment, the removable cap 340 may further comprises a magnetic feature 344 that mates with a magnetic portion of the reel seat insert 322, such as in one embodiment where the reel seat insert 322 is a threaded nut and the magnetic feature 344 is a magnetic button (or a compression fit cap) that snaps onto the threaded nut 322 when the cap 340 is attached to the reel seat 310. The guide inserts 324 and extensions 342 may be different shapes and sizes to ensure the proper orientation of the cap 340 relative to the seat 310 when the cap 340 is attached to the seat 310. For example, certain extensions 342 are longer than others so that the cap 340 may only be attached to the seat 310 in one orientation.

The adaptable handle 350 (see also FIG. 9H) may be any size, shape or construction, and may attach to the reel seat 310 through any type of connection such as a threaded connection, a screw fit connection, a press fit connection, a slide fit connection, a snap fit connection, any type of rotatable fit connection (see FIG. 9F), or the like. While it is preferable that the handle 350 is removably attached to the reel seat 310 as shown, it will be understood that a semi-permanent or permanent-type connection may be desired in certain circumstances. While in the embodiment of FIGS. 9E and 9F, the adaptable handle 350 may be provided with a threaded fastener 352 that attaches to a threaded nut reel seat insert 322 (see also FIGS. 8A and 8B), it will be appreciated that other type of handle connections are possible such as a press fit, a slide fit, a rotatable fit, a rotatable locking fit and the like. The reel seat 310 may be used without a handle 350, in which case the removable cap 340 would be engaged with the reel seat 310 (see FIG. 9G), or it may be used with the handle 350 as shown. While one type of handle is shown, it will be understood that other handle shapes and orientations (relative to the seat) are contemplated. Further, it is contemplated to provide a kit including one or more different types of removable and replaceable handles that are attachable to the reel seat, where such kit may also include at least one reel seat if desired. The handles may include an OEM (original equipment manufacturer) handle that can mate the reel seat. The kit may further include one or more rods, such as the rod 301. The rods may include a plurality of different types of rods, and two of the rods may differ from each other in at least one of physical characteristic and molecular composition.

In the embodiment of FIGS. 9A through 9H, it is preferred that the removable cap 340 is integrated into the reel seat 310 and oriented below the reel location so that the handle 350 extends below the reel and provides a user with a more ergonomic positioning of the rod and reel and allows a user to leverage the adaptable handle when holding the rod and reel seat. Each of the reel seat, removable cap and handle may be constructed in any size, shape or from any material. As for material composition, each component may be made from one or more a combination of the following: cork, wood, graphite or other composite material, titanium, steel, aluminum, rubber polyurethane, nickel, nylon, carbon fiber, or combinations of the same. Other materials, compositions or combinations of the same are contemplated. Further, each component may be milled, molded or formed using methods known in the art.

One or more embodiments of the invention may comprise a grip 120 that is adapted to be heated or cooled. For example, one embodiment of the grip 120 may be attached to a heating or cooling element and a power supply. In some embodiments, the grip 120 may define a hollow area that is adapted to receive and retain a battery and a heating or cooling element. In yet other embodiments, the grip 120 may define a hollow area that is adapted to receive a single-use packet containing chemicals for an endothermic or exothermic reaction.

In other embodiments of the present invention, the grip 120 may be adapted to function as a storage space. For example, in some embodiments the grip 120 may define a space adapted to hold fishing lures, and may comprise a removable lid.

Some embodiments of the present invention may comprise a grip 120 that is adapted to being substantially encapsulated by a viscid material. In one or more embodiments, the grip 120 is adapted to receive a viscid sleeve which may permanently or removably slide or roll onto the grip 120. Other embodiments of the grip 120 may be adapted to adhere to various tacky materials such as tape.

FIGS. 6 A and B illustrate two different cross sectional side views of one embodiment of a partially assembled fishing rod grip 100 of the present invention. As seen in both FIGS. 6 A and B, one or more embodiments of the top half 130 and the bottom half 140 of the bracket 110 are mateable. The through-holes 150 defined by the top half 130 are lined up with the receptor holes 170 defined by the bottom half 140 when the top half 130 is fully mated with the bottom half 140. While mated, a screw 210 may be screwed or inserted through the through-hole 150 and screwed into the hole 170, thereby holding the top half 130 and the bottom half 140 together. While in the mated position, one or more embodiments of the top half 130 and the bottom half 140 define an interior space 220. In one embodiment, the interior space 220 is defined as substantially cylindrical (See FIG. 6 B). The mated top half 130 and bottom half 140 define a space 120 which has a three dimensional structure that approximates the dimensions of a section of a fishing rod. Whether or not the top half 130 and bottom half 140 are mated, the grip 120 may be mated with the bottom half 140 by screwing the bolt 200 projecting from the grip 120 into the empty space 195 that is defined by the projection 190.

As seen in FIG. 6 B, one or more embodiments of the top half 130 and the bottom half 140 of the bracket 110 comprise teeth 230 positioned on the surface that defines the interior space 135, 145, 220. The teeth 230 may be made of any hard or soft material, and may be formed in any shape or size that fits within the boundaries of the space 220 when the top half 130 and bottom half 140 of the bracket 110 are mated.

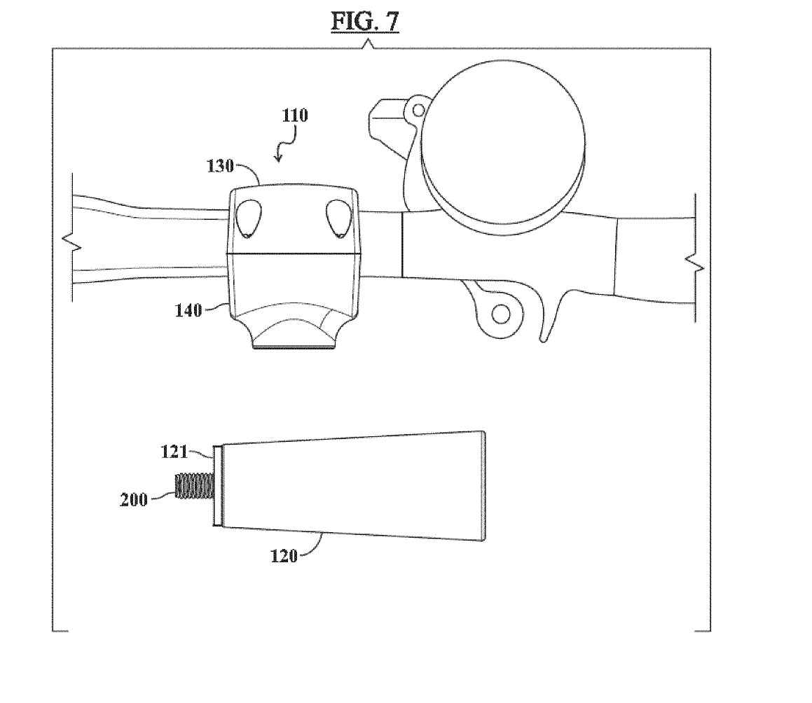

FIG. 7 illustrates an alternative embodiment of the present invention in a partially disassembled state. As seen in FIG. 7, in one or more embodiments the grip 120 is detachable from the bracket 110. In some embodiments, the grip 120 is reversibly mated to the bracket 110 via a bolt 200 that extends from the top 121 of the grip 120. In some embodiments, the bolt 200 may be received by the bottom half 140 of the bracket 110.

In one or more embodiments of the present invention, the top half 130 and bottom half 140 may be attached to one another and/or attached to a generally rod shaped object by a permanent or non-permanent adhesive. The adhesive may be used alone or in combination with bolts that hold the top half 130 and bottom half 140 together, while girdling the generally rod shaped object. The types of possible adhesives include pastes, liquids, films, pellets, tape, hot melt, reactive hot melt, thermosetting, pressure sensitive, contact, structural, semi-structural, or non-structural adhesives.

While the invention has heretofore been described with certain degrees of particularity, there are countless configurations for the grip of the present invention. FIG. 1 through FIG. 12 illustrate only a few possible configurations, and in no way should be construed as limiting the application of the inventive apparatus to those configurations. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A reel seat comprising:
a first attachment to a rod along a longitudinal axis of the reel seat;
a grip having a second attachment to a handle along an attachment axis that is transverse to the longitudinal axis of the reel seat; and
a removable cap covering the second attachment of the grip.

2. The reel seat of claim 1, wherein the removable cap comprises one or more guide features orienting the removable cap relative to the reel seat.

3. The reel seat of claim 2, wherein the guide features include a compression fit connection.

4. The reel seat of claim 2, further comprising a connection through which the grip and the handle are attached to each other, the connection including at least one of a compression fit connection, a slide fit connection, a snap fit connection, a screw fit connection, a press fit connection, a magnetic guide, and a rotatable fit connection.

5. The reel seat of claim 1, further comprising a reel seat insert configured to receive the handle attached to the reel seat.

6. The reel seat of claim 5, wherein the reel seat insert is a threaded fastener.

7. The reel seat of claim 1, further comprising a reel seat slide and a lock mechanism for receiving the handle attached to the grip.

8. The reel seat of claim 1, further comprising a reel seat snap on mechanism for receiving the handle attached to the grip.

9. The reel seat of claim 1, further comprising an additional grip attachment along a longitudinal axis to the rod.

10. A rod comprising at least one reel seat, the at least one reel seat comprising:
a grip having an attachment to a handle; and
a removable cap covering the second attachment of the grip.

11. The rod of claim 10, wherein the at least one reel seat includes a plurality of reel seats that are disposed at different locations of the rod.

12. The rod of claim 10, wherein the attachment of the grip is an attachment along an attachment axis that is transverse to a longitudinal axis of the rod.

13. The rod of claim 10, further comprising a handle attachable to the reel seat.

14. The rod of claim 10, further comprising a plurality of removable and replaceable handles attachable to the reel seat.

15. The rod of claim 10, wherein an angle of one of the at least one reel seat is configured to encompasses the rod 360 degrees.

16. A kit comprising:
at least one rod having a longitudinal axis;
at least one handle; and
at least one reel seat attachable to the at least one rod,
each of the at least one reel seat comprising:
a grip having an attachment to the at least one handle; and
a removable cap configured to be attached to the grip.

17. The kit of claim 16, further comprising a reel seat insert configured to receive the handle attached to the reel seat.

18. The kit of claim 16, wherein the at least one rod includes a plurality of different types of rods.

19. The kit of claim 18, wherein two of the rods differ from each other in at least one of physical characteristic and molecular composition.

20. The kit of claim 16, wherein the attachment of the grip of one of the at least one reel seat is an attachment along an attachment axis that is transverse to a longitudinal axis of the rod.
